(19) United States
(12) Patent Application Publication
(10) Pub. No.: US 2016/0307540 A1
(43) Pub. Date: Oct. 20, 2016

(54) LINEAR SCALING IN A DISPLAY PIPELINE

(71) Applicant: Apple Inc., Cupertino, CA (US)

(72) Inventors: Peter F. Holland, Los Gatos, CA (US); Brijesh Tripathi, Los Altos, CA (US); Guy Cote, San Jose, CA (US)

(21) Appl. No.: 14/691,353

(22) Filed: Apr. 20, 2015

(51) Int. Cl. G09G 5/02

(52) U.S. Cl. CPC G09G 5/02; G09G 2340/06; G09G 2320/0242; G09G 2320/0666; G09G 2320/0673

(57) ABSTRACT

Systems, apparatuses, and methods for performing linear scaling in a display control unit. A display control unit receives source image data that has already been gamma encoded with an unknown gamma value. The display control unit includes a hard-coded LUT storing a gamma curve of a first gamma value which is used to perform a degamma operation on the received source image data. Even if the first gamma value used to perform the degamma operation is different from the gamma value used to gamma encode the source image data, fewer visual artifacts are generated as compared with not performing a degamma operation. After the degamma operation is performed, the source image data may be linearly scaled.

### BACKGROUND

1. Technical Field

Embodiments described herein relate to the field of graphical information processing and more particularly, to performing linear scaling in a display pipe.

2. Description of the Related Art

Part of the operation of many computer systems, including portable digital devices such as mobile phones, notebook computers and the like, is to employ a display device, such as a liquid crystal display (LCD), to display images, video information/streams, and data. Accordingly, these systems typically incorporate functionality for generating images and data, including video information, which are subsequently output to the display device. Such devices typically include video graphics circuitry (i.e., a display pipeline) to process images and video information for subsequent display.

In digital imaging, the smallest item of information in an image is called a “picture element,” more generally referred to as a “pixel.” For convenience, pixels are generally arranged in a regular two-dimensional grid. By using such an arrangement, many common operations can be implemented by uniformly applying the same operation to each pixel independently. Since each pixel is an elemental part of a digital image, a greater number of pixels can provide a more accurate representation of the digital image. To represent a specific color on an electronic display, each pixel may have three values, one each for the amounts of red, green, and blue present in the desired color. Some formats for electronic displays may also include a fourth value, called alpha, which represents the transparency of the pixel. This format is commonly referred to as ARGB or RGBA. Another format for representing pixel color is YCbCr, where Y corresponds to the luma, or brightness, of a pixel and Cb and Cr correspond to two color-difference chrominance components, representing the blue-difference (Cb) and red-difference (Cr).

Most images and video information displayed on display devices such as LCD screens are interpreted as a succession of ordered image frames, or frames for short. While generally a frame is one of the many still images that make up a complete moving picture or video stream, a frame can also be interpreted more broadly as simply a still image displayed on a digital (discrete or progressive scan) display. A frame typically consists of a specified number of pixels according to the resolution of the image/video frame. Most graphics systems use memories (commonly referred to as “frame buffers”) to store the pixels for image and video frame information. The information in a frame buffer typically consists of color values for every pixel to be displayed on the screen. Color values are commonly stored in 1-bit monochrome, 4-bit palletized, 8-bit palletized, 16-bit high color and 24-bit true color formats. An additional alpha channel is oftentimes used to retain information about pixel transparency. The total amount of the memory required for frame buffers to store image/video information depends on the resolution of the output signal, and on the color depth and palette size. The High-Definition Television (HDTV) format, for example, is composed of up to 1080 rows of 1920 pixels per row, or almost 2.1M pixels per frame.

Source image data is often gamma encoded to allow for a more efficient encoding of the source image data. Gamma defines the exponential response curve of the pixel brightness intensity for a given input. In one embodiment, gamma encoding may be performed by calculating the pixel value taken to the power of gamma: (encoded pixel value)=(original pixel value)̂ gamma. A gamma of 1.0 would mean that the pixel intensity was linearly proportional to the input pixel value. When source image data is gamma encoded with a gamma other than 1.0, it makes linear scaling performed on the source image data inaccurate. For example, when interpolating pixel values, the average of two values in gamma space will be different than the average of the same two values in linear space. Performing linear scaling in gamma space rather than in linear space can cause visual artifacts in the scaled image data. Additionally, in many cases, the source image data received by a display pipe may be gamma encoded with an unknown gamma value.

### SUMMARY

Systems, apparatuses, and methods for performing linear scaling in a display pipe are contemplated.

In one embodiment, an apparatus may include at least one display pipe for processing source image data and driving output frame pixels to one or more displays. The display pipe may receive source image data from memory. The display pipe may include a linear scaling unit for performing linear scaling of the received source image data. The received source image data may already be gamma encoded, and the display pipe may store the gamma encoded source image data in one or more line buffers. After storing the gamma encoded source image data in the one or more line buffers, the display pipe may gamma decode the source image so that linear scaling may be performed in linear space rather than in gamma space.

In one embodiment, the gamma value of gamma encoded source image data may be unknown. Accordingly, the display pipe may perform a degamma operation of a fixed gamma value to gamma decode the source image data. In one embodiment, the degamma operation may be performed using hard-coded (e.g., fixed in hardware), or otherwise predetermined, values. For example, the digamma operation may be performed by using a given value without regard to (or even knowledge of) a value that may have been used to perform an original gamma operation. Such values may, for example, be stored in one or more lookup tables (LUTs) in the display pipe or elsewhere. Alternatively, such values may simply be specified in software. In various embodiments, a small number of predetermined values may be used (or even a single value) for use in the digamma operation. In such a manner, area utilized for storing such values may be reduced. Then, after the degamma operation, the display pipe may perform one or more linear scaling operations on the source image data.

In one embodiment, a first gamma-encoded source image with a first gamma value may be received by the display pipe. The display pipe may perform a degamma operation on the first source image using a second gamma value, wherein the second gamma value is different from the first gamma value. Then, linear scaling operations may be performed on the first source image. Next, a second gamma-encoded source image with a third gamma value may be received by the display pipe, wherein the third gamma value is different from the first gamma value, and wherein the third gamma value is different from the second gamma value. The display pipe may perform a degamma operation on the second source image using the second gamma value. Next, linear scaling operations may be performed on the second source image. Additionally, any number of different source images which are gamma-encoded with different gamma values may be gamma decoded by the display pipe using the fixed gamma curve of the second gamma value.

These and other features and advantages will become apparent to those of ordinary skill in the art in view of the following detailed descriptions of the approaches presented herein.

### BRIEF DESCRIPTION OF THE DRAWINGS

The above and further advantages of the methods and mechanisms may be better understood by referring to the following description in conjunction with the accompanying drawings, in which:

FIG. 1 is a block diagram illustrating one embodiment of a system on chip (SOC) coupled to a memory and one or more display devices.

FIG. 2 is a block diagram of one embodiment of a display pipeline for use in a SOC.

FIG. 3 is a block diagram illustrating one embodiment of a display control unit.

FIG. 4 is a block diagram illustrating one embodiment of pixel generation logic.

FIG. 5 illustrates a graph of different types of gamma curve values.

FIG. 6 is a generalized flow diagram illustrating one embodiment of a method for performing degamma operations on source pixel data.

FIG. 7 is a generalized flow diagram illustrating one embodiment of a method for performing degamma operations on a source frame.

FIG. 8 is a block diagram of one embodiment of a system.

### DETAILED DESCRIPTION OF EMBODIMENTS

In the following description, numerous specific details are set forth to provide a thorough understanding of the methods and mechanisms presented herein. However, one having ordinary skill in the art should recognize that the various embodiments may be practiced without these specific details. In some instances, well-known structures, components, signals, computer program instructions, and techniques have not been shown in detail to avoid obscuring the approaches described herein. It will be appreciated that for simplicity and clarity of illustration, elements shown in the figures have not necessarily been drawn to scale. For example, the dimensions of some of the elements may be exaggerated relative to other elements.

This specification includes references to “one embodiment”. The appearance of the phrase “in one embodiment” in different contexts does not necessarily refer to the same embodiment. Particular features, structures, or characteristics may be combined in any suitable manner consistent with this disclosure. Furthermore, as used throughout this application, the word “may” is used in a permissive sense (i.e., meaning having the potential to), rather than the mandatory sense (i.e., meaning must). Similarly, the words “include”, “including”, and “includes” mean including, but not limited to.

Terminology. The following paragraphs provide definitions and/or context for terms found in this disclosure (including the appended claims):

“Comprising.” This term is open-ended. As used in the appended claims, this term does not foreclose additional structure or steps. Consider a claim that recites: “A system comprising a display control unit . . . .” Such a claim does not foreclose the system from including additional components (e.g., a processor, a memory controller).

“Configured To.” Various units, circuits, or other components may be described or claimed as “configured to” perform a task or tasks. In such contexts, “configured to” is used to connote structure by indicating that the units/circuits/components include structure (e.g., circuitry) that performs the task or tasks during operation. As such, the unit/circuit/component can be said to be configured to perform the task even when the specified unit/circuit/component is not currently operational (e.g., is not on). The units/circuits/components used with the “configured to” language include hardware—for example, circuits, memory storing program instructions executable to implement the operation, etc. Reciting that a unit/circuit/component is “configured to” perform one or more tasks is expressly intended not to invoke 35 U.S.C. §112(f) for that unit/circuit/component. Additionally, “configured to” can include generic structure (e.g., generic circuitry) that is manipulated by software and/or firmware (e.g., an FPGA or a general-purpose processor executing software) to operate in a manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks.

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While B may be a factor that affects the determination of A, such a phrase does not foreclose the determination of A from also being based on C. In other instances, A may be determined based solely on B.

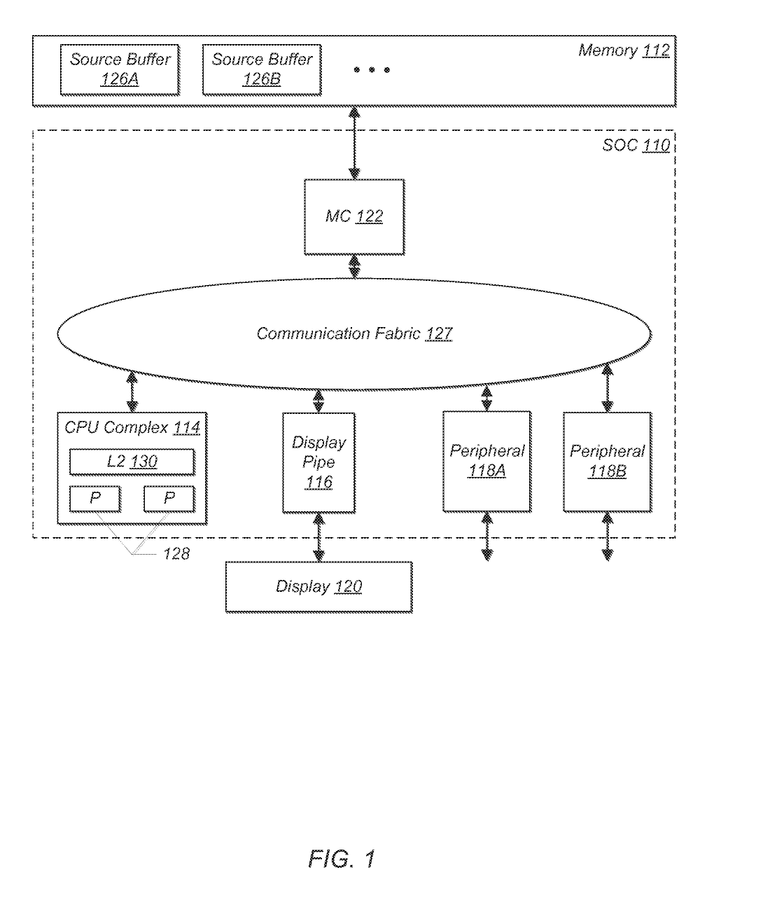

Referring now to FIG. 1, a block diagram of one embodiment of a system on chip (SOC) 110 is shown coupled to a memory 112 and display device 120. A display device may be more briefly referred to herein as a display. As implied by the name, the components of the SOC 110 may be integrated onto a single semiconductor substrate as an integrated circuit “chip.” In some embodiments, the components may be implemented on two or more discrete chips in a system. However, the SOC 110 will be used as an example herein. In the illustrated embodiment, the components of the SOC 110 include a central processing unit (CPU) complex 114, display pipe 116, peripheral components 118A-118B (more briefly, “peripherals”), a memory controller 122, and a communication fabric 127. The components 114, 116, 118A-118B, and 122 may all be coupled to the communication fabric 127. The memory controller 122 may be coupled to the memory 112 during use. Similarly, the display pipe 116 may be coupled to the display 120 during use. In the illustrated embodiment, the CPU complex 114 includes one or more processors 128 and a level two (L2) cache 130.

The display pipe 116 may include hardware to process one or more still images and/or one or more video sequences for display on the display 120. Generally, for each source still image or video sequence, the display pipe 116 may be configured to generate read memory operations to read the data representing respective portions of the frame/video sequence from the memory 112 through the memory controller 122.

The display pipe 116 may be configured to perform any type of processing on the image data (still images, video sequences, etc.). In one embodiment, the display pipe 116 may be configured to scale still images and to dither, scale, and/or perform color space conversion on their respective portions of frames of a video sequence. The display pipe 116 may be configured to blend the still image frames and the video sequence frames to produce output frames for display. Display pipe 116 may also be more generally referred to as a display pipeline, display control unit, or a display controller. A display control unit may generally be any hardware configured to prepare a frame for display from one or more sources, such as still images and/or video sequences.

More particularly, display pipe 116 may be configured to retrieve respective portions of source frames from one or more source buffers 126A-126B stored in the memory 112, composite frames from the source buffers, and display the resulting frames on corresponding portions of the display 120. Source buffers 126A and 126B are representative of any number of source frame buffers which may be stored in memory 112. Accordingly, display pipe 116 may be configured to read the multiple source buffers 126A-126B and composite the image data to generate the output frame.

Display pipe 116 may be configured to perform degamma operations on received gamma-encoded source image data using various techniques which minimize area and power consumption. In various embodiments, a digamma operation is a gamma operation intended to reverse or otherwise remove a previously applied gamma operation. Source image data with different types of gamma encoding may be received by display pipe 116. In one embodiment, display pipe 116 may perform gamma decoding of a fixed gamma value for a plurality of different types of gamma encoded source images corresponding to a plurality of different gamma values. Display pipe 116 may then perform one or more linear scaling operations on a given source image after the given source image has been gamma decoded.

In one embodiment, the degamma operation may raise the source pixel values to the power of the inverse of the gamma exponent, wherein the resultant pixel values will have a linear response from amplitude value to intensity. Accordingly, a corrected pixel component value may be calculated for each gamma-adjusted source pixel component value using a degamma equation. In one embodiment, one or more lookup tables (LUTs) may be used to store the values used to perform the calculation using the degamma equation.

The input pixel values may be described as being in “gamma space” when a gamma curve/correction has been applied to the input pixel values. After the gamma-encoded pixel values have been gamma decoded, then the pixel values may be described as being in “linear space”, wherein being in “linear space” indicates that the pixel values are linear with intensity. If the gamma-encoded input pixel values have been gamma decoded with a gamma value different from the source gamma value, then the input pixel values may be described as being in “pseudo-linear space”. It is noted that if linear scaling operations are performed after the wrong gamma is removed from a given image, this is still better than not gamma decoding the given image and then performing linear scaling operations. For example, if a 2.4 gamma source image is gamma decoded with a gamma of 2.2 and then linearly scaled, the resultant errors (and resultant visual artifacts) will be less than if the 2.4 gamma source image were linearly scaled without being gamma decoded.

The display 120 may be any sort of visual display device. The display 120 may be a liquid crystal display (LCD), light emitting diode (LED), plasma, cathode ray tube (CRT), etc. The display 120 may be integrated into a system including the SOC 110 (e.g. a smart phone or tablet) and/or may be a separately housed device such as a computer monitor, television, or other device. Various types of source image data may be shown on display 120. In various embodiments, the source image data may represent a video clip in a format, such as, for example, Moving Pictures Expert Group-4 Part 14 (MP4), Advanced Video Coding (H.264/AVC), or Audio Video Interleave (AVI). Alternatively, the source image data may be a series of still images, each image considered a frame, that may be displayed in timed intervals, commonly referred to as a slideshow. The images may be in a format such as Joint Photographic Experts Group (JPEG), raw image format (RAW), Graphics Interchange Format (GIF), or Portable Networks Graphics (PNG).

In some embodiments, the display 120 may be directly connected to the SOC 110 and may be controlled by the display pipe 116. That is, the display pipe 116 may include hardware (a “backend”) that may provide various control/data signals to the display, including timing signals such as one or more clocks and/or the vertical blanking period and horizontal blanking interval controls. The clocks may include the pixel clock indicating that a pixel is being transmitted. The data signals may include color signals such as red, green, and blue, for example. The display pipe 116 may control the display 120 in real-time or near real-time, providing the data indicating the pixels to be displayed as the display is displaying the image indicated by the frame. The interface to such display 120 may be, for example, VGA, HDMI, digital video interface (DVI), a liquid crystal display (LCD) interface, a plasma interface, a cathode ray tube (CRT) interface, any proprietary display interface, etc.

The CPU complex 114 may include one or more CPU processors 128 that serve as the CPU of the SOC 110. The CPU of the system includes the processor(s) that execute the main control software of the system, such as an operating system. Generally, software executed by the CPU during use may control the other components of the system to realize the desired functionality of the system. The CPU processors 128 may also execute other software, such as application programs. The application programs may provide user functionality, and may rely on the operating system for lower level device control. Accordingly, the CPU processors 128 may also be referred to as application processors. The CPU complex may further include other hardware such as the L2 cache 130 and/or an interface to the other components of the system (e.g., an interface to the communication fabric 127).

The peripherals 118A-118B may be any set of additional hardware functionality included in the SOC 110. For example, the peripherals 118A-118B may include video peripherals such as video encoder/decoders, image signal processors for image sensor data such as camera, scalers, rotators, blenders, graphics processing units, etc. The peripherals 118A-118B may include audio peripherals such as microphones, speakers, interfaces to microphones and speakers, audio processors, digital signal processors, mixers, etc. The peripherals 118A-118B may include interface controllers for various interfaces external to the SOC 110 including interfaces such as Universal Serial Bus (USB), peripheral component interconnect (PCI) including PCI Express (PCIe), serial and parallel ports, etc. The peripherals 118A-118B may include networking peripherals such as media access controllers (MACs). Any set of hardware may be included.

The memory controller 122 may generally include the circuitry for receiving memory operations from the other components of the SOC 110 and for accessing the memory 112 to complete the memory operations. The memory controller 122 may be configured to access any type of memory 112. For example, the memory 112 may be static random access memory (SRAM), dynamic RAM (DRAM) such as synchronous DRAM (SDRAM) including double data rate (DDR, DDR2, DDR3, etc.) DRAM. Low power/mobile versions of the DDR DRAM may be supported (e.g. LPDDR, mDDR, etc.). The memory controller 122 may include various queues for buffering memory operations, data for the operations, etc., and the circuitry to sequence the operations and access the memory 112 according to the interface defined for the memory 112.

The communication fabric 127 may be any communication interconnect and protocol for communicating among the components of the SOC 110. The communication fabric 127 may be bus-based, including shared bus configurations, cross bar configurations, and hierarchical buses with bridges. The communication fabric 127 may also be packet-based, and may be hierarchical with bridges, cross bar, point-to-point, or other interconnects.

It is noted that the number of components of the SOC 110 (and the number of subcomponents for those shown in FIG. 1, such as within the CPU complex 114) may vary from embodiment to embodiment. There may be more or fewer of each component/subcomponent than the number shown in FIG. 1. It is also noted that SOC 110 may include many other components not shown in FIG. 1. In various embodiments, SOC 110 may also be referred to as an integrated circuit (IC), an application specific integrated circuit (ASIC), or an apparatus.

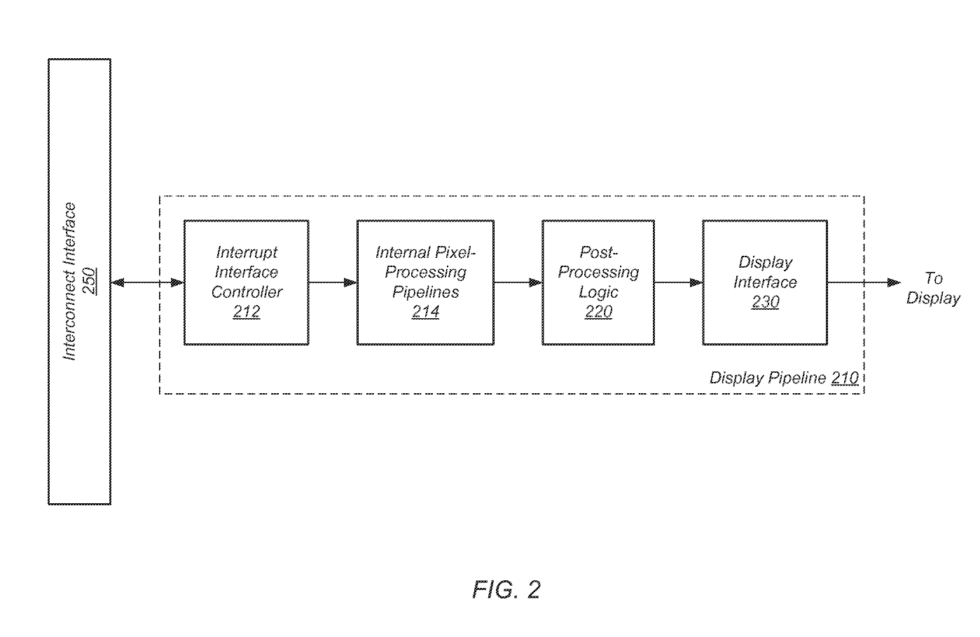

Turning now to FIG. 2, a generalized block diagram of one embodiment of a display pipeline for use in a SoC is shown. Although one display pipeline is shown, in other embodiments, the host SOC (e.g., SOC 110) may include multiple display pipelines. Generally speaking, display pipeline 210 may be configured to process a source image and send rendered graphical information to a display (not shown).

Display pipeline 210 may be coupled to interconnect interface 250 which may include multiplexers and control logic for routing signals and packets between the display pipeline 210 and a top-level fabric. The interconnect interface 250 may correspond to communication fabric 127 of FIG. 1. Display pipeline 210 may include interrupt interface controller 212. Interrupt interface controller 212 may include logic to expand a number of sources or external devices to generate interrupts to be presented to the internal pixel-processing pipelines 214. The controller 212 may provide encoding schemes, registers for storing interrupt vector addresses, and control logic for checking, enabling, and acknowledging interrupts. The number of interrupts and a selected protocol may be configurable.

Display pipeline 210 may include one or more internal pixel-processing pipelines 214. The internal pixel-processing pipelines 214 may include one or more ARGB (Alpha, Red, Green, Blue) pipelines for processing and displaying user interface (UI) layers. The internal pixel-processing pipelines 214 may also include one or more pipelines for processing and displaying video content such as YUV content. In some embodiments, internal pixel-processing pipelines 214 may include blending circuitry for blending graphical information before sending the information as output to post-processing logic 220.

A layer may refer to a presentation layer. A presentation layer may consist of multiple software components used to define one or more images to present to a user. The UI layer may include components for at least managing visual layouts and styles and organizing browses, searches, and displayed data. The presentation layer may interact with process components for orchestrating user interactions and also with the business or application layer and the data access layer to form an overall solution. The YUV content is a type of video signal that consists of one signal for luminance or brightness and two other signals for chrominance or colors. The YUV content may replace the traditional composite video signal. For example, the MPEG-2 encoding system in the DVD format uses YUV content. The internal pixel-processing pipelines 214 may handle the rendering of the YUV content.

The display pipeline 210 may include post-processing logic 220. The post-processing logic 220 may be used for color management, ambient-adaptive pixel (AAP) modification, dynamic backlight control (DPB), panel gamma correction, and dither. The display interface 230 may handle the protocol for communicating with the display. For example, in one embodiment, a DisplayPort interface may be used. Alternatively, the Mobile Industry Processor Interface (MIPI) Display Serial Interface (DSI) specification or a 4-lane Embedded Display Port (eDP) specification may be used. It is noted that the post-processing logic and display interface may be referred to as the display backend.

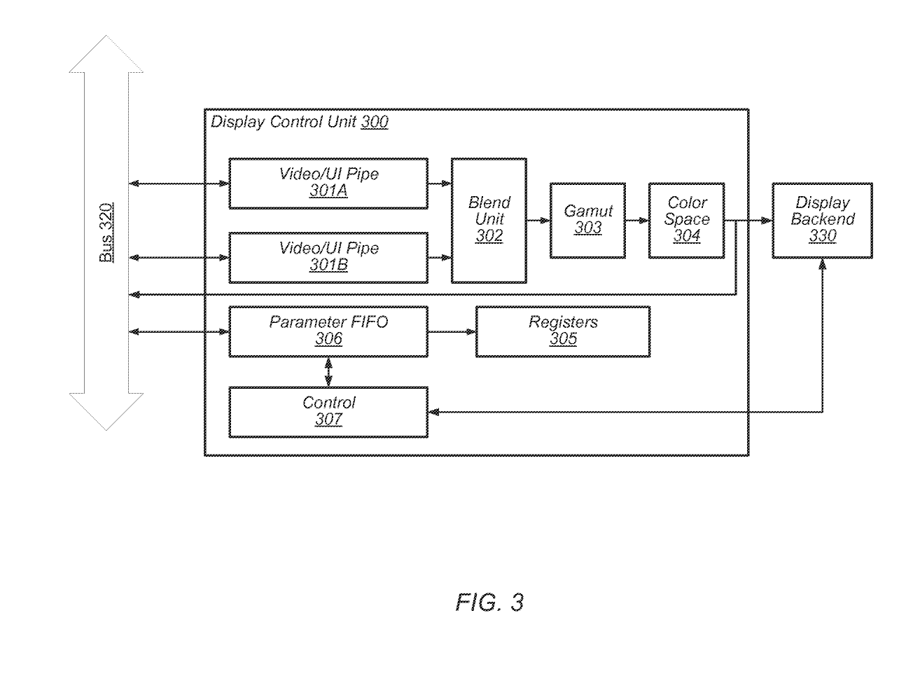

Referring now to FIG. 3, a block diagram of one embodiment of a display control unit 300 is shown. Display control unit 300 may represent the frontend portion of display pipe 116 of FIG. 1. Display control unit 300 may be coupled to a system bus 320 and to a display backend 330. In some embodiments, display backend 330 may directly interface to the display to display pixels generated by display control unit 300. Display control unit 300 may include functional sub-blocks such as one or more video/user interface (UI) pipelines 301A-B, blend unit 302, gamut adjustment block 303, color space converter 304, registers 305, parameter First-In First-Out buffer (FIFO) 306, and control unit 307. Display control unit 300 may also include other components which are not shown in FIG. 3 to avoid cluttering the figure.

System bus 320, in some embodiments, may correspond to communication fabric 127 from FIG. 1. System bus 320 couples various functional blocks such that the functional blocks may pass data between one another. Display control unit 300 may be coupled to system bus 320 in order to receive video frame data for processing. In some embodiments, display control unit 300 may also send processed video frames to other functional blocks and/or memory that may also be coupled to system bus 320. It is to be understood that when the term “video frame” is used, this is intended to represent any type of frame, such as an image, that can be rendered to the display.

The display control unit 300 may include one or more video/UI pipelines 301A-B, each of which may be a video and/or user interface (UI) pipeline depending on the embodiment. It is noted that the terms “video/UI pipeline” and “pixel processing pipeline” may be used interchangeably herein. In other embodiments, display control unit 300 may have one or more dedicated video pipelines and/or one or more dedicated UI pipelines. Each video/UI pipeline 301 may fetch a source image (or a portion of a source image) from a buffer coupled to system bus 320. The buffered source image may reside in a system memory such as, for example, system memory 112 from FIG. 1. Each video/UI pipeline 301 may fetch a distinct source image (or a portion of a distinct source image) and may process the source image in various ways, including, but not limited to, format conversion (e.g., YCbCr to ARGB), image scaling, and dithering. In some embodiments, each video/UI pipeline may process one pixel at a time, in a specific order from the source image, outputting a stream of pixel data, and maintaining the same order as pixel data passes through.

In one embodiment, when utilized as a user interface pipeline, a given video/UI pipeline 301 may support programmable active regions in the source image. The active regions may define the only portions of the source image to be displayed. In an embodiment, the given video/UI pipeline 301 may be configured to only fetch data within the active regions. Outside of the active regions, dummy data with an alpha value of zero may be passed as the pixel data.

Control unit 307 may, in various embodiments, be configured to arbitrate read requests to fetch data from memory from video/UI pipelines 301A-B. In some embodiments, the read requests may point to a virtual address. A memory management unit (not shown) may convert the virtual address to a physical address in memory prior to the requests being presented to the memory. In some embodiments, control unit 307 may include a dedicated state machine or sequential logic circuit. A general purpose processor executing program instructions stored in memory may, in other embodiments, be employed to perform the functions of control unit 307.

Blending unit 302 may receive a pixel stream from one or more of video/UI pipelines 301A-B. If only one pixel stream is received, blending unit 302 may simply pass the stream through to the next sub-block. However, if more than one pixel stream is received, blending unit 302 may blend the pixel colors together to create an image to be displayed. In various embodiments, blending unit 302 may be used to transition from one image to another or to display a notification window on top of an active application window. For example, a top layer video frame for a notification, such as, for a calendar reminder, may need to appear on top of, i.e., as a primary element in the display, despite a different application, an internet browser window for example. The calendar reminder may comprise some transparent or semi-transparent elements in which the browser window may be at least partially visible, which may require blending unit 302 to adjust the appearance of the browser window based on the color and transparency of the calendar reminder. The output of blending unit 302 may be a single pixel stream composite of the one or more input pixel streams.

The output of blending unit 302 may be sent to gamut adjustment unit 303. Gamut adjustment 303 may adjust the color mapping of the output of blending unit 302 to better match the available color of the intended target display. The output of gamut adjustment unit 303 may be sent to color space converter 304. Color space converter 304 may take the pixel stream output from gamut adjustment unit 303 and convert it to a new color space. Color space converter 304 may then send the pixel stream to display backend 330 or back onto system bus 320. In other embodiments, the pixel stream may be sent to other target destinations. For example, the pixel stream may be sent to a network interface for example. In some embodiments, a new color space may be chosen based on the mix of colors after blending and gamut corrections have been applied. In further embodiments, the color space may be changed based on the intended target display.

Display backend 330 may control the display to display the pixels generated by display control unit 300. Display backend 330 may read pixels at a regular rate from an output FIFO (not shown) of display control unit 300 according to a pixel clock. The rate may depend on the resolution of the display as well as the refresh rate of the display. For example, a display having a resolution of N×M and a refresh rate of R fps may have a pixel clock frequency based on N×M×R. On the other hand, the output FIFO may be written to as pixels are generated by display control unit 300.

Display backend 330 may receive processed image data as each pixel is processed by display control unit 300. Display backend 330 may provide final processing to the image data before each video frame is displayed. In some embodiments, display back end may include ambient-adaptive pixel (AAP) modification, dynamic backlight control (DPB), display panel gamma correction, and dithering specific to an electronic display coupled to display backend 330.

The parameters that display control unit 300 may use to control how the various sub-blocks manipulate the video frame may be stored in control registers 305. These registers may include, but are not limited to, setting the frame refresh rate, setting input and output frame sizes, setting input and output pixel formats, location of the source frames, and destination of the output (display backend 330 or system bus 320). Control registers 305 may be loaded by parameter FIFO 306.

Parameter FIFO 306 may be loaded by a host processor, a direct memory access unit, a graphics processing unit, or any other suitable processor within the computing system. In other embodiments, parameter FIFO 306 may directly fetch values from a system memory, such as, for example, system memory 112 in FIG. 1. Parameter FIFO 306 may be configured to update control registers 305 of display processor 300 before each source video frame is fetched. In some embodiments, parameter FIFO may update all control registers 305 for each frame. In other embodiments, parameter FIFO may be configured to update subsets of control registers 305 including all or none for each frame. A FIFO as used and described herein, may refer to a memory storage buffer in which data stored in the buffer is read in the same order it was written. A FIFO may be comprised of RAM or registers and may utilize pointers to the first and last entries in the FIFO.

It is noted that the display control unit 300 illustrated in FIG. 3 is merely an example. In other embodiments, different functional blocks and different configurations of functional blocks may be possible depending on the specific application for which the display pipeline is intended. For example, more than two video/UI pipelines may be included within a display pipeline frontend in other embodiments.

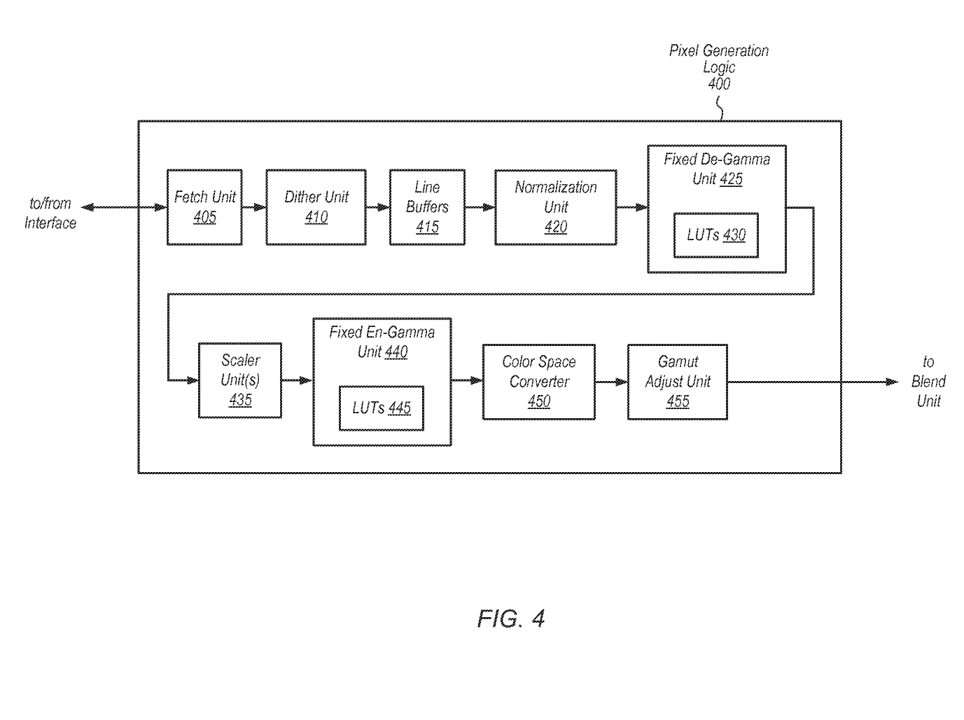

Turning now to FIG. 4, a block diagram of one embodiment of pixel generation logic 400 is shown. Pixel generation logic 400 may correspond to video/UI pipelines 301A and 301B of display control unit 300 as illustrated in FIG. 3. In the illustrated embodiment, pixel generation logic 400 includes fetch unit 405, dither unit 410, line buffers 415, normalization unit 420, fixed de-gamma unit 425, scaler unit(s) 435, fixed en-gamma unit 440, color space converter 450, and gamut adjust unit 455. Pixel generation logic 400 may be responsible for fetching pixel data for source frames stored in a memory, and then processing the fetched data before sending the processed data to a blend unit, such as, blend unit 302 of display control unit 300 as illustrated in FIG. 3.

Fetch unit 405 may be configured to generate read requests for source pixel data being processed by pixel generation logic 400. Each read request may include one or more addresses indicating where the portion of data is stored in memory. In some embodiments, address information included in the read requests may be directed towards a virtual (also referred to herein as “logical”) address space, wherein addresses do not directly point to physical locations within a memory device. In such cases, the virtual addresses may be mapped to physical addresses before the read requests are sent to the source buffer. A memory management unit may, in some embodiments, be used to map the virtual addresses to physical addresses. In some embodiments, the memory management unit may be included within the display pipeline, while in other embodiments, the memory management unit may be located elsewhere within a computing system.

Under certain circumstances, the total number of colors that a given system is able to generate or manage within the given color space—in which graphics processing takes place—may be limited. In such cases, a technique called dithering is used to create the illusion of color depth in the images that have a limited color palette. In a dithered image, colors that are not available are approximated by a diffusion of colored pixels from within the available colors. Dithering in image and video processing is also used to prevent large-scale patterns, including stepwise rendering of smooth gradations in brightness or hue in the image/video frames, by intentionally applying a form of noise to randomize quantization error. Dither unit 410 may, in various embodiments, provide structured noise dithering on the Luma channel of YCbCr formatted data. Other channels, such as the chroma channels of YCbCr, and other formats, such as ARGB may not be dithered.

Line buffers 415 may be configured to store the incoming frame data corresponding to row lines of a respective display screen. The frame data may be indicative of luminance and chrominance of individual pixels included within the row lines. Line buffers 415 may be designed in accordance with one of various design styles. For example, line buffers 415 may be SRAM, DRAM, or any other suitable memory type. In some embodiments, line buffers 415 may include a single input/output port, while, in other embodiments, line buffers 415 may have multiple data input/output ports. In one embodiment, line buffers 415 may store the incoming frame data in gamma space (i.e., gamma encoded frame data), which may allow for a smaller amount of space to be used to store the incoming frame data than if the incoming frame data were stored in linear space.

Next, normalization unit 420 may perform an adjustment on the source pixel data. In various embodiments, normalization unit 420 may be configured to normalize the input pixel values to the range of 0.0 to 1.0. Some source images may be represented in a color space which has a range exceeding 0.0 to 1.0, or some source images may be represented in a color space with a range which uses only a portion of the values from 0.0 to 1.0. In one embodiment, normalization unit 420 may be configured to apply an offset to each input pixel value and then scale the resultant value to perform the normalization. In other embodiments, other techniques for normalizing the input pixel values may be utilized. If the input pixel values are already normalized, then normalization unit 420 may be a passthrough unit, or the input pixel values may bypass normalization unit 420.

Next, fixed de-gamma unit 425 may perform a gamma decoding operation using a fixed gamma value for all source frames regardless of the source gamma values used to convert the source frames to gamma space. In one embodiment, the fixed gamma value may be a gamma of 2.2 as specified by the International Telecommunication Union (ITU) Recommendation 709 (Rec. 709). In other embodiments, other gamma values may be utilized. By using a fixed gamma value, the area and power consumption of fixed de-gamma unit 425 may be minimized. Additionally, in embodiments where most source frames are expected to be gamma encoded with the same or a similar gamma curve value, the gamma-to-linear space conversion error when using the fixed gamma value to perform the de-gamma operation should be minimal (or zero when the fixed gamma value matches the source gamma value). Fixed de-gamma unit 425 may utilize lookup tables (LUTs) 430 for storing the values of the fixed gamma curve. In some embodiment, the LUTs may be hard-coded and be designed according to any of various design styles. For example, the LUTs may include read-only memory (ROM), or any other suitable memory circuit. Fixed de-gamma unit 425 may also include bilinear interpolation logic for performing the de-gamma operations using the values obtained from LUTs 430. For example, in one embodiment, two entries may be retrieved from LUTs 430 for each input pixel value using an upper portion of the input pixel value, and then a lower portion of the input pixel value may be utilized to interpolate between the two entries. Other embodiments may utilize other techniques for performing the fixed de-gamma operation.

In another embodiment, to reduce the gamma-to-linear space conversion error of using a fixed de-gamma value for performing the de-gamma operation, fixed de-gamma unit 420 may store two (or other small numbers) gamma curves of fixed gamma values for performing the de-gamma operation. When the source gamma value of a received source image is known, then fixed de-gamma unit 420 may select the fixed gamma value which is closest to the source gamma value. When the source gamma value is unknown, then fixed de-gamma unit 420 may generate a prediction as to which fixed gamma value is likely to be closest to the source gamma value and then fixed de-gamma unit 420 may select the gamma curve which is predicted to be the best fit for performing the de-gamma operation on the received source image. Alternatively, when the source gamma value is unknown, fixed de-gamma unit 420 may always select one of the two fixed gamma curves to be used. In a further embodiment, when the source gamma value is unknown, fixed de-gamma unit 420 may randomly select between the two gamma curves.

After the de-gamma operation has been performed by fixed de-gamma unit 420, scaler unit(s) 435 may be configured to perform scaling on the source pixel data which has been converted to pseudo-linear space. In some embodiments, scaling of source pixels may be performed in two steps. The first step may perform a vertical scaling, and the second step may perform a horizontal scaling. In the illustrated embodiment, scaler unit(s) 435 may perform the vertical and horizontal scaling. Scaler unit(s) 435 may be designed according to any of varying design styles. In some embodiments, the vertical scaler and horizontal scaler of scaler unit(s) 435 may be implemented as 9-tap 32-phase filters. These multi-phase filters may, in various embodiments, multiply each pixel retrieved by fetch unit 405 by a weighting factor. The resultant pixel values may then be added, and then rounded to form a scaled pixel. The selection of pixels to be used in the scaling process may be a function of a portion of a scale position value. In some embodiments, the weighting factors may be stored in a programmable table, and the selection of the weighting factors to use in the scaling may be a function of a different portion of the scale position value.

After scaling has been performed by scaler unit(s) 435, the scaled source pixel data may be converted back to gamma space by fixed en-gamma unit 440 using LUTs 445. Fixed en-gamma unit 440 may perform a gamma operation using a gamma curve with a gamma value specific to the display device of the host device. In one embodiment, the values in LUTs 445 used for performing the gamma operation may be hard-coded.

Color management within pixel generation logic 400 may be performed by color space converter 450 and gamut adjust unit 455. In some embodiments, color space converter 425 may be configured to convert YCbCr source data to the RGB format. Alternatively, color space converter may be configured to remove offsets from source data in the RGB format. Color space converter 425 may, in various embodiments, include a variety of functional blocks, such as an input offset unit, a matrix multiplier, and an output offset unit (all not shown). The use of such blocks may allow the conversion from YCbCr format to RGB format and vice-versa.

In various embodiments, gamut adjust unit 455 may be configured to convert pixels from a non-linear color space to a linear color space, and vice-versa. In some embodiments, gamut adjust unit 455 may include a LUT and an interpolation unit. The LUT may, in some embodiments, be programmable and be designed according to one of various design styles. For example, the LUT may include a SRAM or DRAM, or any other suitable memory circuit. In some embodiments, multiple LUTs may be employed. For example, separate LUTs may be used for Gamma and De-Gamma calculations. It is noted that the embodiment illustrated in FIG. 4 is merely an example. In other embodiments, different functional blocks and different configurations of functional blocks may be utilized.

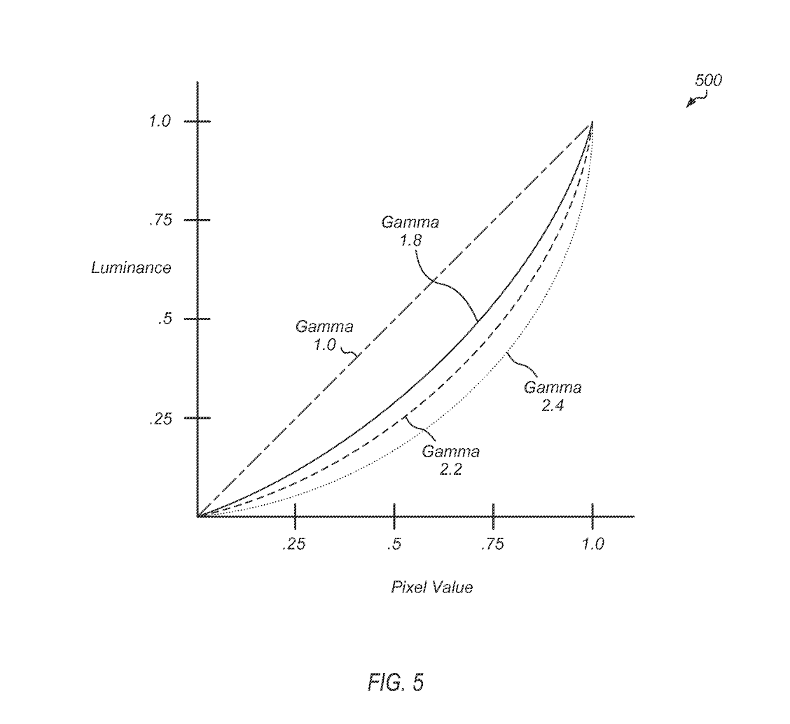

Referring now to FIG. 5, a graph 500 of different types of gamma curve values are shown. The graph 500 of the gamma curves is shown with luminance value versus pixel value. Luminance is shown as ranging from 0.0 to 1.0 and pixel value is shown with a normalized range of 0.0 to 1.0. A gamma curve of 1.0 is shown as a straight line at a 45 degree angle through graph 500. A gamma curve of 1.0 indicates that no gamma has been applied to the source frame. A gamma curve of 1.8 is also shown underneath the gamma curve of 1.0. Also, gamma curves of 2.2 and 2.4 are also shown as the bottom two curves of graph 500. It is noted that other source frames may be converted into gamma space utilizing gamma curves with other gamma values.

In one embodiment, a display control unit may be configured to utilize a fixed gamma value for performing degamma operations on all received source frames. Different received source frames may have been converted into gamma space utilizing different gamma values, but the display control unit may utilize the fixed gamma value for performing degamma operations, with the gamma curve values hard-coded into one or more tables to minimize the area utilized by the degamma unit. In some cases, the display control unit may not know the gamma value which was used to convert a given source frame into gamma space. In these cases, when there is a mismatch between the fixed gamma value and the unknown source gamma value, performing the degamma operation using the fixed gamma value on a given source frame will convert the given source frame into pseudo-linear space. However, this approach is an improvement as compared to not performing a degamma operation on the given source frame, especially when linear scaling is performed on the given source frame. In other words, performing linear scaling on an image in pseudo-linear space will result in less error than performing linear scaling on the image in gamma space. The term “pseudo-linear space” may be defined as a close approximation to linear space. The “pseudo-linear space” may also be defined as an approximation to linear space attained when a gamma-encoded source image is gamma-decoded with a gamma value not equal to the source gamma value.

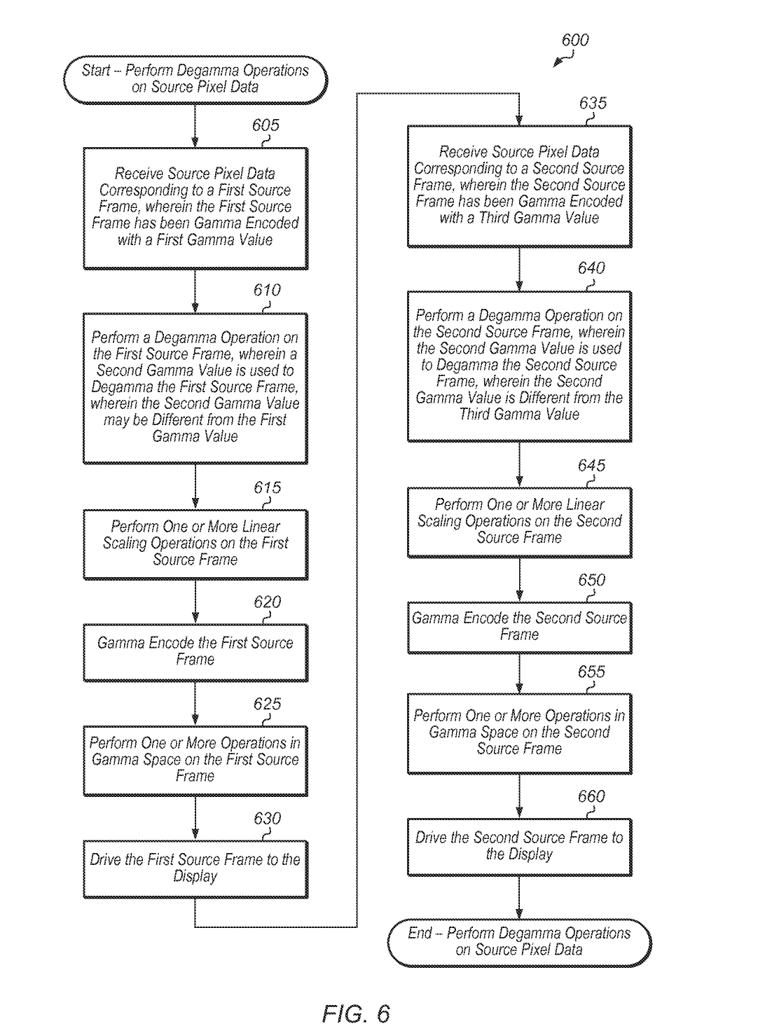

Referring now to FIG. 6, one embodiment of a method 600 for performing degamma operations on source pixel data is shown. For purposes of discussion, the steps in this embodiment are shown in sequential order. It should be noted that in various embodiments of the method described below, one or more of the elements described may be performed concurrently, in a different order than shown, or may be omitted entirely. Other additional elements may also be performed as desired. Any of the various systems, apparatuses, and display control units described herein may be configured to implement method 600.

A display control unit of a host apparatus may receive source pixel data corresponding to a first source frame, wherein the first source frame has been gamma encoded with a first gamma value (block 605). The display control unit may be coupled to a memory (via a communication fabric), and the display control unit may be coupled to a display (via a display interface). Depending on the embodiment, the host apparatus may be a mobile device (e.g., tablet, smartphone), wearable device, computer, or other computing device. The display control unit may perform a degamma operation on the first source frame, wherein the degamma operation uses a second gamma value to degamma the first image, and wherein the second gamma value may (or may not) be different from the first gamma value (block 610). Next, the display control unit may perform one or more linear scaling operations on the source pixel data of the first source frame (block 615). Then, the display control unit may gamma encode the source pixel data of the first source frame (block 620). In one embodiment, the display control unit may apply a gamma value which is based on the response of the specific display coupled to the display control unit on which the first source frame will be displayed. Alternatively, the display control unit may apply a gamma value which is the inverse of the degamma operation using the second gamma value. Next, the display control unit may perform one or more operations in gamma space on the first source frame (block 625). Next, the display control unit may drive the first source frame to the display (block 630). It is noted that the first source frame may be referred to as an output frame when driven to the display. It is further noted that the first source frame may be combined with one or more other source frames to create a composite output frame which is driven to the display.

Next, the display control unit may receive source pixel data corresponding to a second source frame, wherein the second source frame has been gamma encoded with a third gamma value (block 635). It may be assumed for the purposes of this discussion that the third gamma value is different from the first gamma value and that the third gamma value is different from the second gamma value. It may also be assumed that the second source frame is subsequent to the first source frame in the frame sequence being displayed. The display control unit may perform a degamma operation on the source pixel data of the second source frame, wherein the degamma operation uses the second gamma value to degamma the second source frame (block 640). Next, the display control unit may perform one or more linear scaling operations on the source pixel data of the second source frame (block 645). Then, the display control unit may gamma encode the source pixel data of the second source frame (block 650). Next, the display control unit may perform one or more operations in gamma space on the second source frame (block 655). Next, the display control unit may drive the second source frame to the display (block 660). After block 660, method 600 may end.

It is noted that method 600 may be repeated for any number of source frames that have different types of gamma encoding values applied to their pixel data. Regardless of the gamma encoding value which has been applied to the source pixel data of any received source frame, the display control unit may utilize the second gamma value to perform the degamma operation on the received source frame.

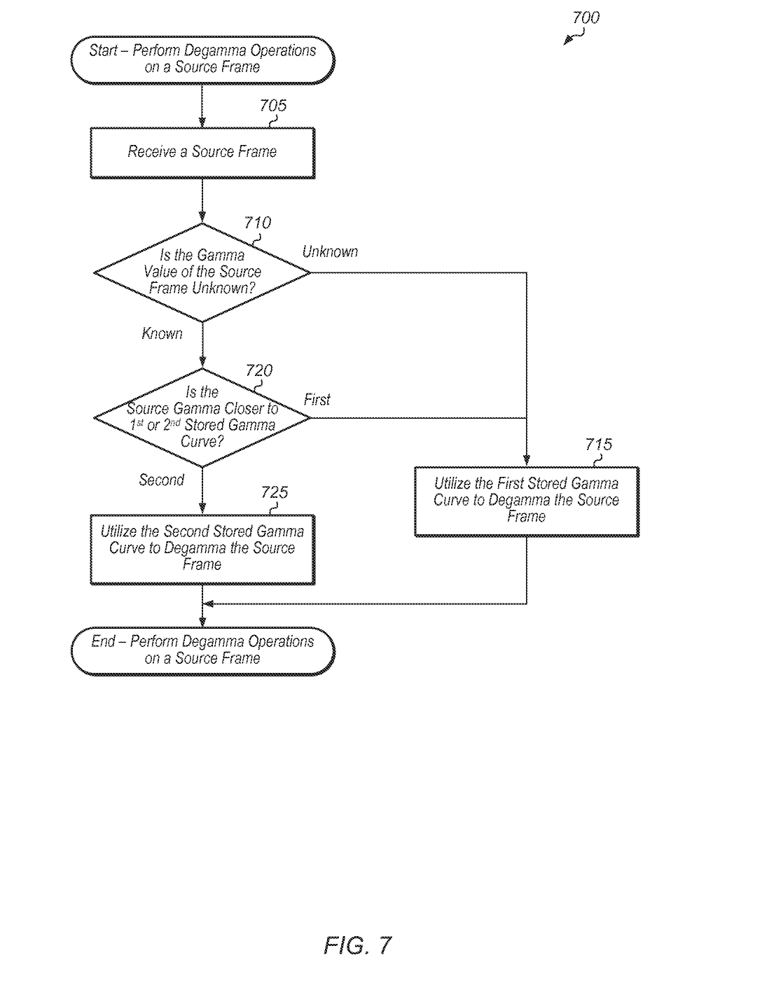

Turning now to FIG. 7, another embodiment of a method 700 for performing degamma operations on a source frame is shown. For purposes of discussion, the steps in this embodiment are shown in sequential order. It should be noted that in various embodiments of the method described below, one or more of the elements described may be performed concurrently, in a different order than shown, or may be omitted entirely. Other additional elements may also be performed as desired. Any of the various systems, apparatuses, and display control units described herein may be configured to implement method 700.

A display control unit may receive a source frame for processing (block 705). The display control unit may determine if the gamma value used to gamma encode the source frame is known (conditional block 710). If the gamma value used to gamma encode the source frame is unknown (conditional block 710, “unknown” leg), then the display control unit may utilize a first stored gamma curve to degamma the source frame (block 715). If the gamma curve applied to the source frame is known (conditional block 710, “known” leg), then the display control unit may determine if the source gamma value used to gamma encode the source frame is closer to the first gamma value of the first stored gamma curve or the second gamma value of the second stored gamma curve (conditional block 720). It may be assumed for the purposes of the discussion regarding method 700 that the display control unit has two stored gamma curve LUTs for performing degamma operations on received source frames. In other embodiments, the display control unit may include other numbers of stored gamma curve LUTs for performing degamma operations on received source frames.

If the gamma value used to encode the source frame is closer to the first gamma value of the first stored gamma curve (conditional block 720, “first” leg), then the display control unit may utilize the first stored gamma curve to degamma the source frame (block 715). After block 715, method 700 may end. If the gamma curve applied to the source frame is closer to the second gamma value of the second stored gamma curve (conditional block 720, “second” leg), then the display control unit may utilize the second stored gamma curve to degamma the source frame (block 725). After block 725, method 700 may end.

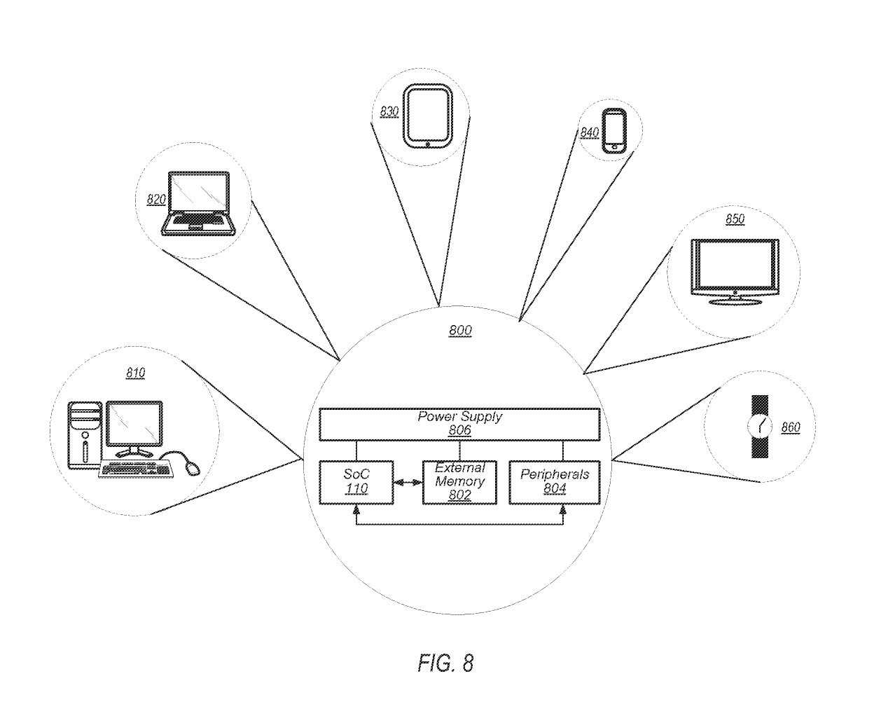

Referring next to FIG. 8, a block diagram of one embodiment of a system 800 is shown. As shown, system 800 may represent chip, circuitry, components, etc., of a desktop computer 810, laptop computer 820, tablet computer 830, cell phone 840, television 850 (or set top box configured to be coupled to a television), wrist watch or other wearable item 860, or otherwise. Other devices are possible and are contemplated. In the illustrated embodiment, the system 800 includes at least one instance of SoC 110 (of FIG. 1) coupled to an external memory 802.

SoC 110 is coupled to one or more peripherals 804 and the external memory 802. A power supply 806 is also provided which supplies the supply voltages to SoC 110 as well as one or more supply voltages to the memory 802 and/or the peripherals 804. In various embodiments, power supply 806 may represent a battery (e.g., a rechargeable battery in a smart phone, laptop or tablet computer). In some embodiments, more than one instance of SoC 110 may be included (and more than one external memory 802 may be included as well).

The memory 802 may be any type of memory, such as dynamic random access memory (DRAM), synchronous DRAM (SDRAM), double data rate (DDR, DDR2, DDR3, etc.) SDRAM (including mobile versions of the SDRAMs such as mDDR3, etc., and/or low power versions of the SDRAMs such as LPDDR2, etc.), RAMBUS DRAM (RDRAM), static RAM (SRAM), etc. One or more memory devices may be coupled onto a circuit board to form memory modules such as single inline memory modules (SIMMs), dual inline memory modules (DIMMs), etc. Alternatively, the devices may be mounted with SoC 110 in a chip-on-chip configuration, a package-on-package configuration, or a multi-chip module configuration.

The peripherals 804 may include any desired circuitry, depending on the type of system 800. For example, in one embodiment, peripherals 804 may include devices for various types of wireless communication, such as wifi, Bluetooth, cellular, global positioning system, etc. The peripherals 804 may also include additional storage, including RAM storage, solid state storage, or disk storage. The peripherals 804 may include user interface devices such as a display screen, including touch display screens or multitouch display screens, keyboard or other input devices, microphones, speakers, etc.

In various embodiments, program instructions of a software application may be used to implement the methods and/or mechanisms previously described. The program instructions may describe the behavior of hardware in a high-level programming language, such as C. Alternatively, a hardware design language (HDL) may be used, such as Verilog. The program instructions may be stored on a non-transitory computer readable storage medium. Numerous types of storage media are available. The storage medium may be accessible by a computer during use to provide the program instructions and accompanying data to the computer for program execution. In some embodiments, a synthesis tool reads the program instructions in order to produce a netlist comprising a list of gates from a synthesis library.

It should be emphasized that the above-described embodiments are only non-limiting examples of implementations. Numerous variations and modifications will become apparent to those skilled in the art once the above disclosure is fully appreciated. It is intended that the following claims be interpreted to embrace all such variations and modifications.

What is claimed is:

1. A display control unit configured to:
receive first source image data, wherein the first source image data has been gamma encoded with an unknown gamma value;
perform a degamma operation of a first gamma value on the first source image data; and
perform one or more linear scaling operations on the first source image data subsequent to performing the degamma operation on the first source image data.

2. The display control unit as recited in claim 1, wherein the degamma operation is performed using a predetermined value.

3. The display control unit as recited in claim 1, wherein the display control unit is further configured to reapply a gamma encoding to the first source image data subsequent to performing the one or more linear scaling operations on the first source image data, wherein the gamma encoding is an inverse of the degamma operation of the first gamma value.

4. The display control unit as recited in claim 1, wherein the display control unit is further configured to store the first source image data in one or more line buffers prior to performing the degamma operation.

5. The display control unit as recited in claim 1, wherein the display control unit is further configured to:
receive second source image data, wherein the second source image data has been gamma encoded with a second gamma value, wherein the second gamma value is different from the first gamma value;
perform a degamma operation of the first gamma value on the second source image data; and
perform one or more linear scaling operations on the second source image data subsequent to performing the degamma operation on the second source image data.

6. The display control unit as recited in claim 2, wherein the predetermined value is hard-coded.

7. The display control unit as recited in claim 1, wherein the display control unit is further configured to normalize the first source image data prior to performing the degamma operation on the first source image data.

8. A computing system comprising:
a display; and
a display control unit configured to:
receive first source image data, wherein the first source image data has been gamma encoded with an unknown gamma value;
perform a degamma operation of a first gamma value on the first source image data; and
perform one or more linear scaling operations on the first source image data subsequent to performing the degamma operation on the first source image data.

9. The computing system as recited in claim 8, wherein the degamma operation is performed using a predetermined value

10. The computing system as recited in claim 8, wherein the display control unit is further configured to reapply a gamma encoding to the first source image data subsequent to performing the one or more linear scaling operations on the first source image data, wherein the gamma encoding is an inverse of the degamma operation of the first gamma value.

11. The computing system as recited in claim 8, wherein the display control unit is further configured to store the first source image data in one or more line buffers prior to performing the degamma operation.

12. The computing system as recited in claim 8, wherein the display control unit is further configured to:
receive second source image data, wherein the second source image data has been gamma encoded with a second gamma value, wherein the second gamma value is different from the first gamma value;
perform a degamma operation of the first gamma value on the second source image data; and
perform one or more linear scaling operations on the second source image data subsequent to performing the degamma operation on the second source image data.

13. The computing system as recited in claim 8, wherein the predetermined value is hard-coded.

14. The computing system as recited in claim 8, wherein the display control unit is further configured to normalize the first source image data prior to performing the degamma operation on the first source image data.

15. A method comprising:
receiving first source image data, wherein the first source image data has been gamma encoded with an unknown gamma value;
performing a degamma operation of a first gamma value on the first source image data; and
performing one or more linear scaling operations on the first source image data subsequent to performing the degamma operation on the first source image data.

16. The method as recited in claim 15, wherein the degamma operation is performed using a predetermined value.

17. The method as recited in claim 15, further comprising reapplying a gamma encoding to the first source image data subsequent to performing the one or more linear scaling operations on the first source image data, wherein the gamma encoding is an inverse of the degamma operation of the first gamma value.

18. The method as recited in claim 15, further comprising storing the first source image data in one or more line buffers prior to performing the degamma operation.

19. The method as recited in claim 15, further comprising:
receiving second source image data, wherein the second source image data has been gamma encoded with a second gamma value, wherein the second gamma value is different from the first gamma value;
performing a degamma operation of the first gamma value on the second source image data; and
performing one or more linear scaling operations on the second source image data subsequent to performing the degamma operation on the second source image data.

20. The method as recited in claim 15, further comprising normalizing the first source image data prior to performing the degamma operation on the first source image data.
